(19) United States
(12) Patent Application Publication
(10) Pub. No.: US 2002/0088164 A1
(43) Pub. Date: Jul. 11, 2002

(54) Ice eliminator

(76) Inventor: Brian Ernest Koepke, Eveleth, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/759,288

(22) Filed: Jan. 11, 2001

(51) Int. Cl. A01M 1/00

(52) U.S. Cl. 43/1

(57) ABSTRACT

The present invention is an apparatus and method for reducing the formation of ice in an ice-fishing hole. The ice elimination apparatus comprises a first hold insert that is insertable into an ice-fishing hole. This first insertable portion is slightly smaller in diameter than the diameter of the hole. An insulating cover apparatus is then placed over the hole containing the hole insert so as to not touch the water.

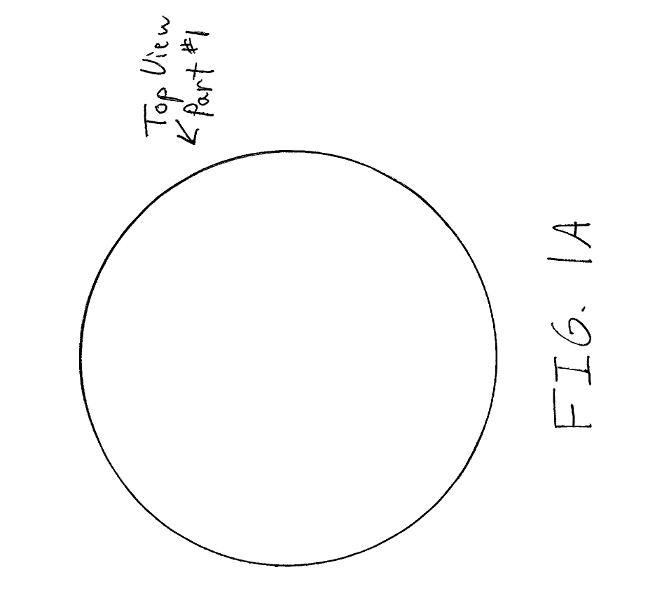

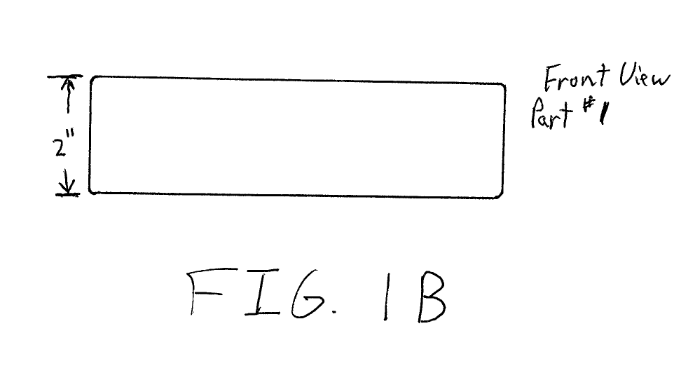

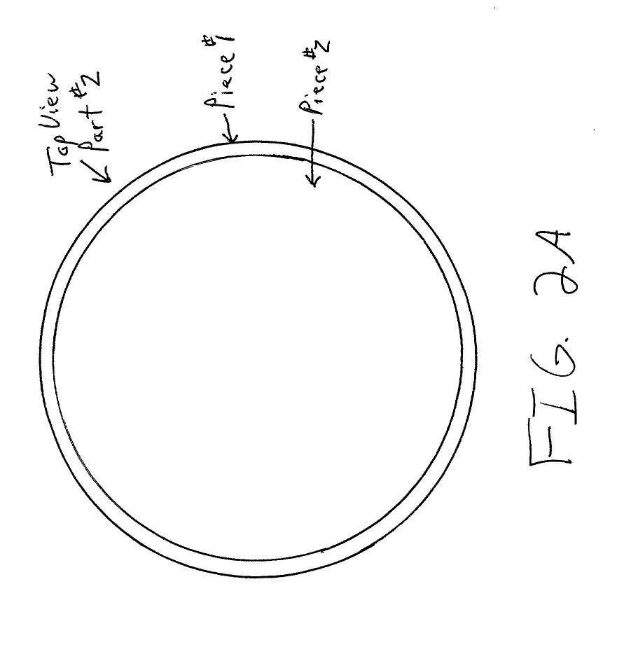

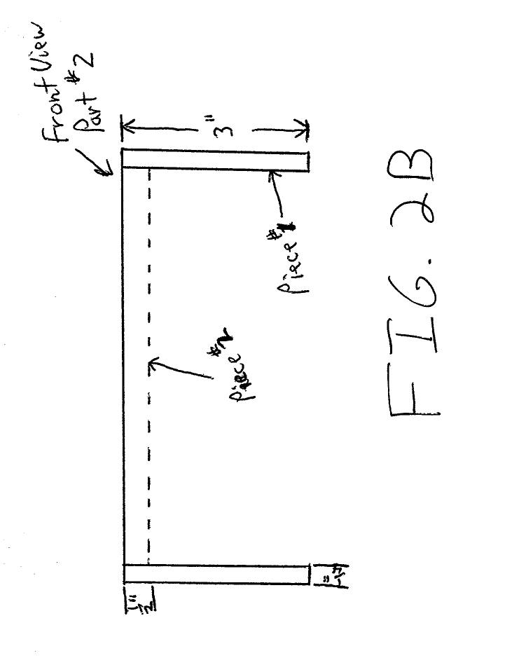

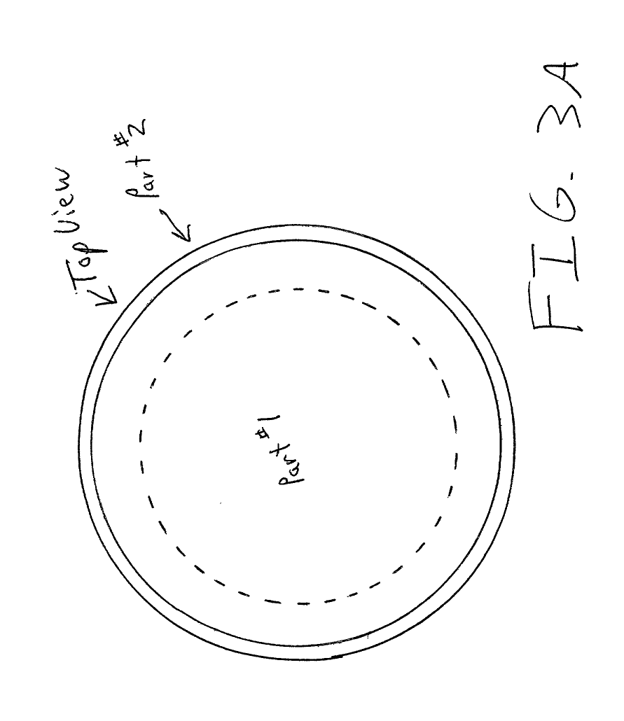

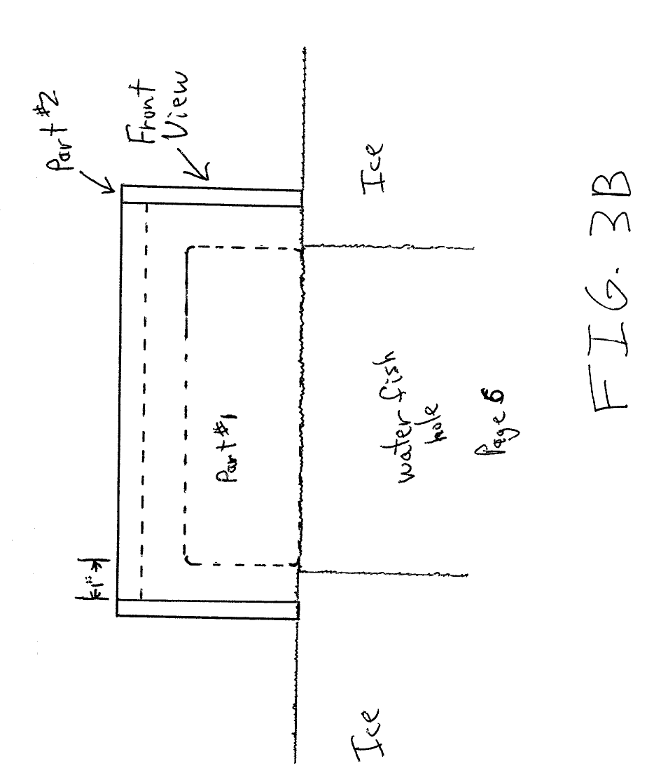

### BACKGROUND OF THE INVENTION

Ice Fishing

Winter fishing through the ice from inside a fishing shelter is very popular in northern areas. A common problem among people who either fish or spear fish through the ice from a shelter is of having to recut or chop open the hole after being gone a day or several days.

### BRIEF SUMMARY OF THE INVENTION

The “Ice Eliminator” slows down ice from forming in the hole, so when the fisherman comes back, he does not have to spend alot of time, energy, and making noise before being able to start fishing.

The “Ice Eliminator consist of two parts. The first part is placed floating on top of the open water in the hole which is only about one-quarter inch bigger around than that part. Next the second insulater cover part is placed over the hole but is not allowed to be in the water, and will not be if the hole matches closely the size of the first part. Generally on a winters night in areas where ice fishing is done, the ice will freeze over the hole an average of one-half to three inches thick, depending on how cold it is. Over a 24-hour period with an average temperature of ten degrees farenhite, the ice will not form under the “Ice Eliminator”. At minus twenty degrees farenhite there may be an eighth inch of ice. The more days a person is away the more the ice may form. However at temperatures above fifteen degrees, there will not be any ice formation under the “Ice Eliminator” even a week later. At temperatures below fifteen degrees, for say a week later, there will be only about one-half an inch of ice around the edges underneith, while getting thinner towards the center. The “Ice Eliminator” will seperate from the frozen ice when tapped lightly, or harder depending on how much ice has been allowed to form under it, will then pull loose from the ice. On all occations the ice will form around the outside edges of the first part of the “Ice Eliminator” that floats on top of the water. After the fisherman removes the “Ice Eliminator” from the hole and does his fishing, it may be nessasary to cut or chop the edges of the hole very slightly. The “Ice Eliminator” part must be floating directly on open water and not slightly resting on the ice surface around the hole. Otherwise ice will form quicker in the hole.

### BRIEF DESCRIPTION OF THE SEVERAL VIEWS OF THE DRAWINGS

Referance Page #4,

Part #1 is made from blue polystyrene board that is two inches thick from the front view, and will be marketed in various sizes from six to twelve inch diameters for fishing, and from various square and rectangular sizes up to thirty-six inches for spear fishing. As you can see from the front view, the edges have been slightly rounded.

Referance Page #5,

Part #2-Piece #2, is to be made from blue polystyrene board that is one-half inch thick from the front view, and to be two inches larger across than Part #1.

Part #2-Piece #1, is to be made from one-quarter inch thick tiny bubble sponge plastic. It is cut three inches wide and is glued on the upper edge to Part #2-Piece #2 so as to wrap around it forming a larger cover like piece.

Referance Page #6,

The top view of this drawing shows Part #1 inside of Part #2. The front view also shows Part #1 inside of Part #2 as the completed “Ice Eliminator” in its functional stage on the fishing hole and ice.

### DETAILED DESCRIPTION OF THE INVENTION

As you can see, the “Ice Eliminator” is a very simple invention that serves the purpose of saving the winter ice fisherman from alot of time, energy, and hassle of re-opening of the fish hole in the fish shelter. It also greatly reduces the noise from having to re-open the fish hole which in turn doesn't scare away or spook the fish. You catch more fish this way.

The blue polystyrene board is available from any building supply store in the two inch and one-half inch thicknesses. The blue polystyrene board can be cut with a hacksaw blade or hot wire to make the differant size circles or square-rectangular shapes. The flat side edges of Part #1 are first lightly sanded with #80 grit sandpaper. Then use #180 grit sandpaper again to further smoothen the cut edge while just slightly taking off the sharp corners to form a rounded edge as in the front view of the drawing. Finally sand this same area with #600 grit sandpaper just enough to smoothen nicely.

Cut out Part #2-Piece #2 so it will overlap one inch larger in all areas when set atop Part #1 of the same shape. After cutting out Part #2-Piece #2 from the one-half inch blue polystyrene board, it is only neccasary to sand the flat edge with #80 grit sandpaper without rounding the sharp edge.

The one-quarter inch thick tiny bubble sponge plastic for Part #2-Piece #1 is available from auto upholstery suppliers. It is cut three inches wide and long enough to wrap around Part #2-Piece #2. It will be glued on with polystyrene glue available where you get the blue polystyrene board from. Put glue around the edge of Part #2-Piece #2 and place into position as in the drawing on page #5. Transparent tape can be used to hold into position until the glue dries. Also put a little glue on the ends of Part #2-Piece #1 to eliminate the end seams from opening up.

Before putting Part #1 on top of the open water in the ice fishing hole, take a little petroleum jelly and smear a thin coating on the bottom and edges of it This is not absolutely neccasary but it does help keep Part #1 from sticking to the ice if left for long periods of time. It also extends the life of the edges of Part #1, because over time the edges will flake away and need to be resanded to keep it easy on pulling loose from the ice.

What I claim as my invention called the “Ice Iliminator” is:

1. It will greatly slow down the ice formation process in the fishing hole inside a fishing shelter allowing the fisherman to quickly and easily get set up to start fishing, after being gone away from the shelter for several days.
